(19) United States
(12) Patent Application Publication
(10) Pub. No.: US 2002/0118833 A1
(43) Pub. Date: Aug. 29, 2002

(54) Compact and low-cost system for receiving scrambled signals from a plurality of operators

(76) Inventor: Herve Benoit, Paris (FR)

Correspondence Address: U.S. Philips Corporation, 580 White Plains Road, Tarrytown, NY, 10591, US

(21) Appl. No.: 10/084,755

(22) Filed: Feb. 25, 2002

(30) Foreign Application Priority Data
Feb. 27, 2001 (FR) 0102664

(51) Int. Cl. H04N 7/167

(52) U.S. Cl. 380/210; 380/201

(57) ABSTRACT

The invention relates to a system intended to receive encoded and scrambled data signals DS, which system comprises:

a decoder DEC,

an output device DISP provided with means to generate output stimuli on the basis of output signals OS from said decoder,

descrambling means DES for descrambling the data signals DS, which are activated by an enabling signal ES,

enabling means EN, which are intended to receive protected information from an operator and supply the enabling signal ES.

The invention enables the user to receive programs originating from different operators, in such a manner that neither the cost of and the space taken up by said system nor the risk that the contents of these programs is fraudulently copied become prohibitively high. Application: Digital television program receivers.

The invention relates to a system intended to receive encoded and scrambled data signals and process these signals in order to convert them to output stimuli that can be readily understood by a user of this system.

Such systems are currently used in the electronics industry to, inter alia, pick up and display digital television programs. The currently employed systems generally comprise:

a decoder,

descrambling means, and

an output device, for example a television receiver or a monitor, to generate the output stimuli, in this case images and sounds, on the basis of the output signals from the decoder.

In the present state of the digital television program market, the programs being formed by arrays of digital signals, and in the present state of the hardware and appurtenances used, these programs are encoded in accordance with audiovisual data compression standards of the MPEG type. Each data signal transmitter, which is commonly referred to as the operator, designs a decoder specifically to descramble and decode, i.e. decompress, its own programs, which means that the decoder is accommodated in a housing wherein generally the descrambling means are included. Such a decoder is incapable of descrambling and hence decoding programs originating from another operator. A user who wishes to receive programs originating from a plurality of operators must thus have a corresponding number of different housings-decoders at his disposal, which brings about a substantial increase in costs and in space occupied by the multiple-operator system thus formed.

It is an object of the invention to enable a user to receive programs originating from different operators, using a system such that the above-mentioned drawbacks do not occur.

In accordance with the invention, the decoder and the descrambling means included in the system in accordance with the opening paragraph can be accommodated in the output device, said system additionally comprising enabling means, which are intended to receive protected information from a transmitter of the data signals and supply an enabling signal following upon the reception of said information, said enabling signal being intended to activate the descrambling means.

In such a system, the descrambling means only effectively descramble the data signals if they are enabled to do so by the transmitter of the signals, i.e. generally after the user of the system has effected a transaction with the relevant operator.

A plurality of hypotheses can be made regarding the functioning: the descrambling means may comprise standard descrambling software for all programs that can be received by the system, and each program can only be descrambled by means of a key that is specific to this program, which key is defined by the operator transmitting this program. In such a hypothesis, the key can form the enabling signal. In this hypothesis, descrambled data signals will be available at the output of the descrambling means if the latter are included in a stand-alone module, and might well be intercepted by a malevolent user who wants to fraudulently copy the contents of the decoded program.

It is thus desirable to make adaptations in order to preclude that the user of the system can have access to descrambled signals.

To achieve this, the descrambling means are advantageously included in the decoder.

If, in addition, the decoder itself is included in the output device, the only information that is directly accessible to the user will be protected information provided by the transmitter of the data signals, as a result of which the risk that the contents of programs received by the system is fraudulently copied is reduced.

In another hypothesis, the descrambling means may include hardware for executing a descrambling software program, without said descrambling means containing the software itself however, since in this case the software will be transported, by means of the enabling signal, to the descrambling means where it will be stored. Such a transport will take place subject to the reception of protected information by the enabling means, which protected information may contain a code defining the descrambling program. In this other hypothesis, it would be possible to incorporate the enabling means in the decoder, which may or may not be integrated in the output device, so that said descrambling software program is not directly accessible to the user of the system and hence the risk that the contents of programs is fraudulently copied is limited. Such an embodiment of the invention additionally enables a further reduction of the place taken up by the system.

In accordance with a particular embodiment of the invention, the decoder is provided with an interface so as to enable data to be exchanged with peripheral equipment of the output device, the enabling signal being intended to be transferred from the enabling means to the descrambling means via this interface.

Such an embodiment takes advantage of the fact that most decoders will, in the near future, be provided with a standard interface, for example of the USB type, thereby enabling preexistent resources to be used to transfer the enabling signal.

In accordance with an embodiment of the invention, the enabling means comprise a memory wherein protected information is stored.

In this embodiment, each operator must provide the enabling means that are specific to said operator, which enabling means are intended to be connected to the output device. Nevertheless, the system is more compact than the known multiple-operator systems as the enabling means which, in this embodiment, will be essentially composed of a memory and an associated connector are smaller than a housing-decoder combination.

In another embodiment of the invention, the enabling means include a detachable memory medium reader, the protected information being intended to be stored in the memory of this medium.

This embodiment enables both the cost of and the space taken up by the system to be further reduced because only a single reader is necessary, the system being adapted to the constraints of a new operator by changing the detachable memory medium in a simple manner. The enabling means may additionally be provided with a plurality of connectors, each connector being intended to receive a detachable memory medium provided by an operator.

The detachable memory media may appear in different forms, and are advantageously used in the form of memory sticks or chip cards.

A modification of the invention, according to which the enabling means are provided with a modem allowing a real-time data exchange to take place between the system and a transmitter of data signals, is advantageous in that it enables, apart from downloading information protected by the operator transmitting the data signals, a bi-directional communication between the user and different operators, thus enabling, for example, transactions to be effected, particularly in pay television or teleshopping applications.

Although the system described hereinabove is a television system, the invention is not limited to this sole application. The example can be used, for example, within the framework of conditional reception of radio programs or also in the framework of protected telecommunications, where the output stimuli will be exclusively sound signals.

In one of its embodiments, the invention also relates to a method of descrambling and decoding data signals within a system intended to convert said signals into output stimuli that can be readily understood by a user of this system, which method includes a step of transferring a descrambling software program, from enabling means intended to receive protected information from a transmitter of data signals, to descrambling means comprising hardware for executing said software program.

These and other aspects of the invention will be apparent from and elucidated with reference to the non-limitative exemplary embodiment and the annexed drawings, wherein:

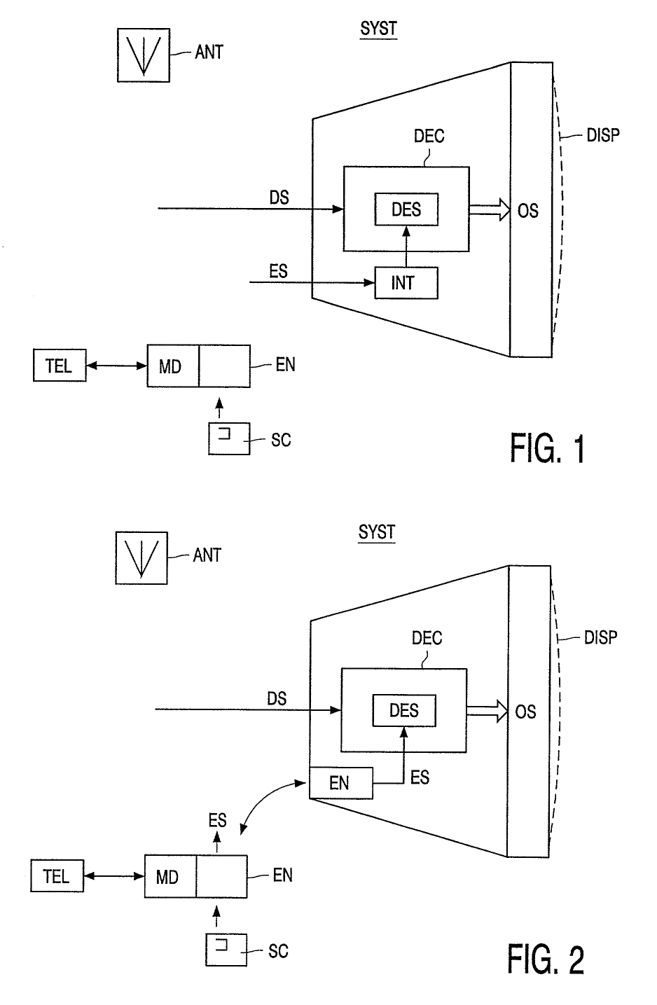

FIG. 1 is a functional diagram of a reception system in accordance with an embodiment of the invention, and

FIG. 2 is a functional diagram of a reception system in accordance with a particularly advantageous modification of said embodiment of the invention.

FIG. 1 diagrammatically shows a system SYST intended to receive, from an antenna ANT, encoded and scrambled data signals DS and process these signals DS in order to convert them to output stimuli that can be readily understood by a user of this system SYST, which system comprises:

an output device DISP, including a decoder DEC of data signals DS, and provided with means for generating the output stimuli on the basis of the output signals OS from the decoder DEC,

descrambling means DES for descrambling the data signals DS, said means being included in the output device DISP and intended to be activated by an enabling signal ES,

enabling means EN, which are intended to receive protected information from a transmitter of data signals, and to supply the enabling signal ES following upon the reception of said information.

In the example described here, the output device is provided with display means, such as a cathode ray tube, or even a liquid crystal display screen or a plasma screen, the output stimuli being images and sounds. The output signals OS from the decoder DEC will be used to control these display means.

In such a system, the descrambling means DES do not effectively descramble the data signals DS until they are authorized to do so by the transmitter of the signals, i.e. generally after the user of the system SYST has effected a transaction with the relevant operator, which will then supply protected information to the user.

The descrambling means DES may comprise standard descrambling software for all programs that can be received by the system SYST, descrambling of each program only being possible by means of a key that is specific to each individual program, which key is defined by the operator, which is the transmitter of the program. In such a hypothesis, the key may be contained in the protected information and constitute the enabling signal ES. In another hypothesis, the descrambling means DES may contain hardware for executing a descrambling software program, but the descrambling means do not contain the software itself, so that in this case said software program will be transferred, by means of the enabling signal ES, to the descrambling means DES where it will be stored. Such a transport will take place subject to the reception of protected information by the enabling means EN. This protected information could contain a code that defines the descrambling software. In accordance with the particular embodiment of the invention described here, the descrambling means DES are included in the decoder DEC, which is provided with an interface INT to enable data to be exchanged with peripheral equipment of the output device DISP, the enabling signal ES being intended to be transferred from the enabling means EN to the descrambling means DES via said interface INT.

This embodiment takes advantage of the fact that most decoders will, in the near future, be provided with a standard interface, for example of the USB or IEEE1394 type, thereby enabling preexistent resources to be used to transfer the enabling signal ES. The enabling means EN thus include a chip card reader SC, said card being provided by an operator after the user of the system SYST has effected a transaction with this operator, and said card SC comprising a memory wherein the protected information is to be stored. Thus, when the user wishes to access programs from a new operator, it is sufficient to insert a new, relevant chip card into the enabling means EN. The invention clearly enables both the cost of and the space taken up by the system SYST to be reduced substantially, since, in accordance with the prior art, a user who wishes to receive programs originating from a plurality of different operators must have an equally large number of different housing-decoder combinations, whereas, in the example described here, the invention only requires a single chip card reader and a set of chip cards provided by said operators.

In the system SYST described with reference to this Figure, the enabling means EN are provided with a modem MD enabling a real-time data exchange to take place, via a telephone line TEL, between the system SYST and a transmitter of data signals. This modification of the invention is advantageous because it enables information protected by an operator to be downloaded, for example for updating purposes, but also bi-directional communication between the user and different operators, which enables, for example, transactions to be effected, particularly, in pay television or teleshopping applications.

FIG. 2 diagrammatically shows a modification of the system SYST described hereinabove. Elements in this Figure that correspond to elements of the preceding Figure bear the same reference numerals and are not described again. In accordance with this modification, the enabling means EN are accommodated in the output device DISP, which thus includes a connector intended to receive the medium containing the protected information, for example a chip card SC, and a connector intended to connect the modem MD to a telephone line TEL.

This modification enables a further reduction of the space taken up by the system SYST, and additionally has the following advantage:

If the hypothesis is made that the descrambling software is transferred from the enabling means EN to the descrambling means DES via the enabling signal ES, said software is fully operational and may be intercepted by a malevolent user who wants to make an illegal copy of the contents of the decoded program.

The modification of the invention described here precludes that the user of the system SYST can have direct access to the descrambling software. By virtue of the fact that the enabling means EN are included in the output device DISP, the only information that can be directly accessed by the user from outside said device is protected information provided by the transmitter of data signals, as a result of which the risk of fraudulently copying the content of programs received by the system is limited.

With a view to limiting the cost of the output device DISP, and in order to enable the modem MD to be substituted with improved versions throughout the service life of the output device DISP, it is possible to separate the modem MD from the enabling means EN, as a result of which the modem will be a peripheral device situated outside the device DISP.

1. A system intended to receive encoded and scrambled data signals and process these signals in order to convert them to output stimuli that can be readily understood by a user of this system, which comprises:
a data signal decoder,
an output device provided with means for generating the output stimuli on the basis of output signals from the decoder,
descrambling means for descrambling the data signals, said means being intended to be activated by an enabling signal,
enabling means, which are intended to receive protected information from a transmitter of data signals, and to supply the enabling signal following upon the reception of said information
wherein the descrambling means comprise hardware for executing a conditional access software program for controlling the descrambling of said data signals, said software program being intended to be transported to the descrambling means by the enabling signal.

2. A system as claimed in claim 1, wherein the descrambling means are included in the decoder.

3. A system as claimed in claim 1, wherein the enabling means are incorporated in the decoder.

4. A system as claimed in claim 1, wherein the decoder is incorporated in the output device.

5. A system as claimed in claim 2, wherein the decoder is provided with an interface so as to enable data to be exchanged with peripheral equipment, and wherein the conditional access software program is intended to be transferred from the enabling means to the descrambling means via this interface by the enabling signal.

6. A system as claimed in claim 1, wherein the enabling means comprise a memory wherein the protected information is stored including said conditional access software program for controlling the descrambling.

7. A system as claimed in claim 1, wherein the enabling means include a detachable memory medium reader, the protected information being intended to be stored in the memory of this medium.

8. A system as claimed in claim 8, wherein the detachable memory medium is a chip card.

9. A system as claimed in claim 1, wherein the enabling means are provided with a modem enabling a real-time data exchange between the system and a transmitter of data signals.

10. A method of descrambling and decoding data signals within a system intended to convert said signals into output stimuli that can be readily understood by a user of this system, which process includes a step of transferring a conditional access software program, from enabling means intended to receive protected information from a transmitter of data signals, to descrambling means comprising hardware for executing said software program.
